(19) United States
(12) Patent Application Publication
(10) Pub. No.: US 2007/0083685 A1
(43) Pub. Date: Apr. 12, 2007

(54) Data management for a USB device

(75) Inventors: Hung-Yuan Hsu, Hsinchu Hsien (TW); Ching-Lin Chung, Hsinchu Hsien (TW); Ho Le-Chun, Hsinchu Hsien (TW); Chien-Hsing Hsieh, Hsinchu Hsien (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: PIXART IMAGING INC., Hsinchu Hsien (TW)

(21) Appl. No.: 11/248,942

(22) Filed: Oct. 11, 2005

(51) Int. Cl. G06F 13/38

(52) U.S. Cl. 710/69

(57) ABSTRACT

A data management method for a USB device includes the steps of: sampling an analog input signal, and generating digital sample data corresponding to samples of the analog input signal; monitoring the number of the digital sample data generated within a predefined time interval; if the number of the digital sample data generated at the end of the predefined time interval matches a predetermined value, providing the digital sample data to a USB host; and if the number of the digital sample data generated at the end of the predefined time interval does not match the predetermined value, processing the digital sample data such that the number of the processed digital sample data matches the predetermined value, and providing the processed digital sample data to the USB host. A USB device including a data management module for implementing the data management method is also disclosed.

### BACKGROUND OF THE INVENTION

1. Field of the Invention

This invention relates to a data management method and module for a USB device, more particularly to a data management method and module for processing digital sample data generated by a USB device.

2. Description of the Related Art

Universal serial bus (USB) devices for multi-media applications are well known in the art. Conventionally, as illustrated in FIG. 1, a USB device 9 includes first and second data management modules 91, 94, and a USB interface 93. The first data management module 91 handles audio data, whereas the second data management module 94 handles data other than the audio data, such as video data. The first data management module 91 includes an analog-to-digital converter (ADC) 911 and a controller 912. The ADC 911 is coupled to a microphone 8 for receiving an audio input signal, samples the audio input signal at a sampling frequency, and generates digital sample data that correspond to samples of the audio input signal and that are to be provided to a personal computer 7. The controller 912 is coupled to the ADC 911, has a built-in buffer, temporarily stores a predetermined number of the digital sample data in the buffer thereof within a predefined time interval, and is operable to provide the stored digital sample data to the personal computer 7 at the end of the predefined time interval. The USB interface 93 is coupled to the controller 912 and the personal computer 7, and converts the digital sample data into a signal that complies with a USB specification for subsequent receipt by the personal computer 7. The personal computer 7 periodically generates start of frame (SOF) signals at intervals of approximately one millisecond, which is received by the controller 912 through the USB interface 93. The predefined time interval is defined by two successive SOF signals.

The aforementioned conventional USB device 9 is disadvantageous in that, since the personal computer 7 and the ADC 911 of the USB device 9 may not be synchronized, either a deficient number of the digital sample data is stored in the buffer of the controller 912 in the case of data underflow, or desired ones of the digital sample data stored in the buffer of the controller 912 are overwritten by excess ones of the digital sample data in the case of data overflow. In either case, an undesirable popping noise is generated when the audio input signal is reproduced by the personal computer 7.

### SUMMARY OF THE INVENTION

Therefore, the object of the present invention is to provide a data management method and module for processing digital sample data generated by a USB device prior to transmission so as to overcome the aforesaid drawbacks of the prior art.

According to one aspect of the present invention, a data management method for a USB device includes the steps of: sampling an analog input signal at a sampling frequency, and generating digital sample data corresponding to samples of the analog input signal; monitoring the number of the digital sample data generated within a predefined time interval; if the number of the digital sample data generated at the end of the predefined time interval matches a predetermined value, providing the digital sample data to a USB host; and if the number of the digital sample data generated at the end of the predefined time interval does not match the predetermined value, processing the digital sample data such that the number of the processed digital sample data matches the predetermined value, and providing the processed digital sample data to the USB host.

According to another aspect of the present invention, a data management module for a USB device comprises a data processing unit. The USB device includes an analog-to-digital converter that samples an analog input signal at a sampling frequency and that generates digital sample data corresponding to samples of the analog input signal. The data processing unit is adapted to be coupled between the analog-to-digital converter and a USB host. The data processing unit is operable so as to monitor the number of the digital sample data generated within a predefined time interval, so as to provide the digital sample data to the USB host if the number of the digital sample data generated at the end of the predefined time interval matches a predetermined value, and so as to process the digital sample data such that the number of the processed digital sample data matches the predetermined value and so as to provide the processed digital sample data to the USB host if the number of the digital sample data generated at the end of the predefined time interval does not match the predetermined value.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic block diagram of a conventional universal serial bus (USB) device coupled between a microphone and a personal computer;

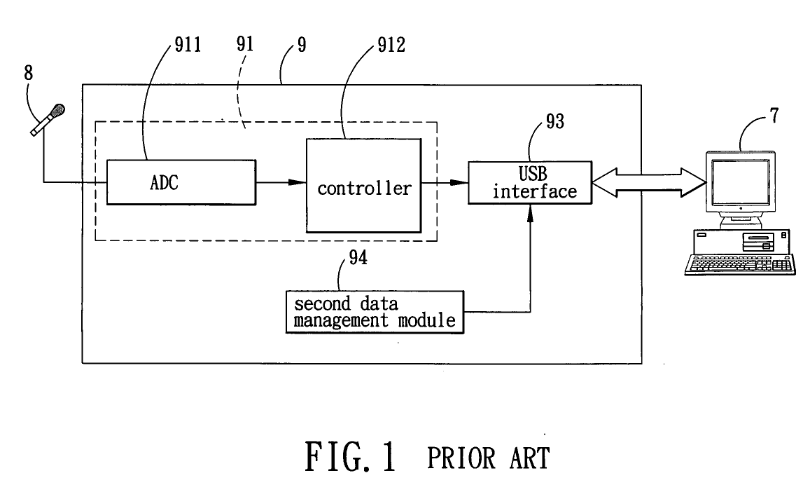

FIG. 2 is a schematic block diagram of the first preferred embodiment of a data management module for a USB device according to the present invention;

FIG. 3 is a schematic view to illustrate addressable storage locations of a buffer in the first preferred embodiment;

FIG. 4 is a flowchart of the preferred embodiment of a data management method according to this invention;

FIGS. 5A to 5I are time charts to illustrate how data write operation of the buffer in the first preferred embodiment is managed according to this invention; and

FIG. 6 is a schematic block diagram of the second preferred embodiment of a data management module for a USB device according to this invention.

### DETAILED DESCRIPTION OF THE PREFERRED EMBODIMENTS

Before the present invention is described in greater detail, it should be noted that like elements are denoted by the same reference numerals throughout the disclosure.

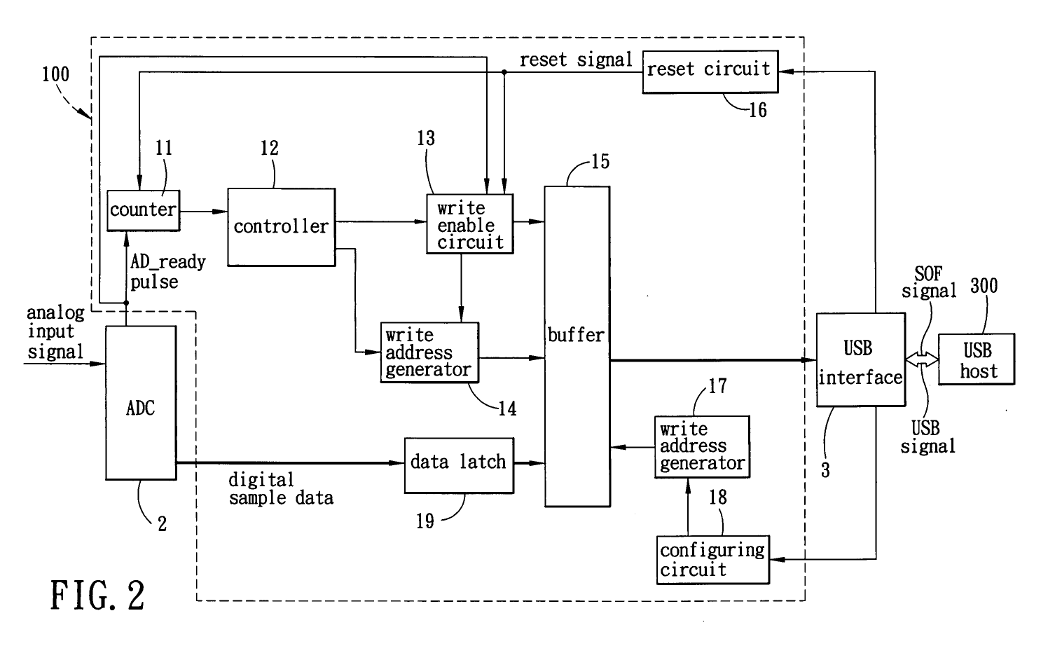

Referring to FIG. 2, the first preferred embodiment of a data management module for a universal serial bus (USB) device according to this invention includes a data processing unit 100.

The USB device, which is embodied in a composite USB device suitable for multi-media applications, includes an analog-to-digital converter (ADC) 2 and a USB interface 3. The ADC 2 receives an analog input signal, such as an audio signal, samples the analog input signal at a sampling frequency, such as 8 KHz or 16 KHz, and generates digital sample data that correspond to samples of the analog input signal and that are provided to a USB host 300, such as a personal computer. The USB interface 3 is coupled to the USB host 300, and converts the digital sample data from the data processing unit 100 into a USB signal that complies with a USB specification for subsequent receipt by the USB host 300.

The data processing unit 100 is coupled between the ADC 2 and the USB interface 3. In this embodiment, the data processing unit 100 is operable so as to monitor the number of the digital sample data generated within a predefined time interval, so as to provide the digital sample data to the USB interface 3 if the number of the digital sample data generated at the end of the predefined time interval matches a predetermined value, and so as to process the digital sample data such that the number of the processed digital sample data matches the predetermined value and so as to provide the processed digital sample data to the USB interface 3 if the number of the digital sample data generated at the end of the predefined time interval does not match the predetermined value, in a manner that will be described hereinafter.

It is noted herein that the USB host 300 periodically generates start-of-frame (SOF) signals at intervals of approximately 1 millisecond. Moreover, the predefined time interval is defined as the interval between two consecutive SOF signals. Further, the ADC 2 generates an AD_ready pulse for every digital sample data generated thereby.

In this embodiment, the data processing unit 100 includes a counter 11, a reset circuit 16, a buffer 15, a data latch 19, a write enable circuit 13, a controller 12, write and read address generators 14, 17, and a configuring circuit 18.

The counter 11 is connected electrically to the ADC 2 for receiving the AD_ready pulse, monitors the number of digital sample data generated by the ADC 2 by counting the number of AD_ready pulses received from the ADC 2, and is reset at the start of the predefined time interval through the reset circuit 16. In particular, the reset circuit 16 is connected electrically to the counter 11 and the USB interface 3, receives the SOF signals from the USB host 300 through the USB interface 3, and generates a reset signal, in response to the SOF signal, for resetting the counter 11.

The buffer 15 temporarily stores the digital sample data that are to be provided to the USB host 300 through the USB interface 3, and has a number of addressable storage locations equal to the predetermined value. In this embodiment, the buffer 15 is a 32-byte first-in first-out buffer memory that has sixteen addressable storage locations.

The data latch 19 is connected electrically to the ADC 2 and the buffer 15, and is operable so as to latch a latest one of the digital sample data from the ADC 2.

The write enable circuit 13 is connected electrically to and controls write operation of the buffer 15. It is noted that the write enable circuit 13 is further connected electrically to the ADC 2 for receiving the AD_ready pulse, and the reset circuit 16 for receiving the reset signal.

The controller 12 is connected electrically to counter 11 and the write enable circuit 13, and is configured with the predetermined value. The controller 12 regularly compares the number of digital sample data monitored by the counter 11 with the predetermined value configured therein.

The write address generator 14 is connected electrically to the buffer 15 and the controller 12, and is controlled by the controller 12 to generate an address location at which the digital sample data is written to the buffer 15.

If the controller 12 determines that the number of the digital sample data monitored by the counter 11 within the predefined time interval is less than the predetermined value configured therein, the controller 12 controls the write enable circuit 13, as well as the write address generator 14, to enable write operation of the buffer 15 within the predefined time interval. As such, when the write enable circuit 13 receives the AD_ready pulse from the ADC 2, the digital sample data latched in the data latch 19 is stored in the buffer 15 at the address location generated by the write address generator 14.

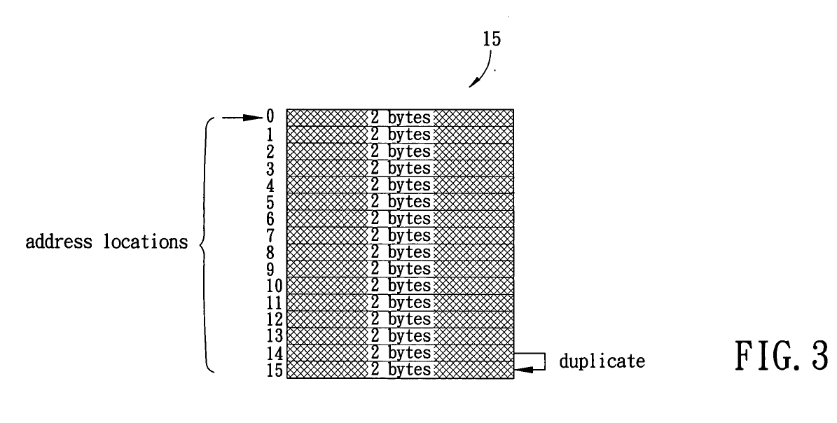

If the controller 12 determines that the number of the digital sample data monitored by the counter 11 at the end of the predefined time interval is less than the predetermined value configured therein, the controller 12 controls the write enable circuit 13 to enable write operation of the buffer 15 at the end of the predefined time interval. As such, when the write enable circuit 13 receives the reset signal from the reset circuit 16, the digital sample data latched in the data latch 19 is stored in the buffer 15. As illustrated in FIG. 3, in the case where only fifteen sets of digital sample data were generated by the end of the predefined time interval, the digital sample data at the addressable storage location #14 of the buffer 15 is duplicated at the addressable storage location #15 of the buffer 15, thereby resulting in the processed digital sample data that includes compensating sample data at the addressable storage location #15 of the buffer 15.

On the other hand, if the controller 12 determines that the number of the digital sample data monitored by the counter 11 by the end of the predefined time interval is greater than the predetermined value configured therein, i.e., the monitored number of the digital sample data has exceeded the predetermined value before the expiry of the predefined time interval, the controller 12 controls the write enable circuit 13 to disable further write operation of the buffer 15. In other words, when the write enable circuit 13 receives the AD_ready pulse from the ADC 2 or the reset signal from the reset circuit 16, the latest one of the digital sample data latched in the data latch 19 is not stored in the buffer 15. As such, the desired ones of the digital sample data stored in the buffer 15 are not overwritten by the excess ones of the digital sample data, and the excess ones of the digital sample data are simply discarded.

The read address generator 17 is connected electrically to the buffer 15, and is operable so as to generate an address location at which the digital sample data is read from the buffer 15.

The configuring circuit 18 is connected electrically to the read address generator 17 and the USB interface 3, and is operable so as to set a maximum number (or isochronous number) of the digital sample data to be read from the buffer 15 without interruption and within the predefined time interval.

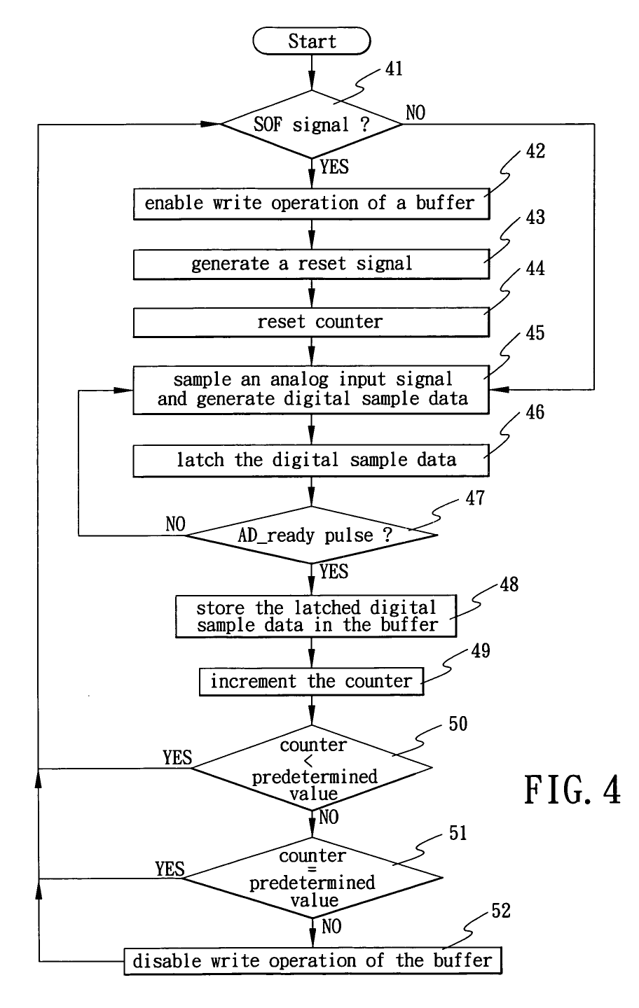

The preferred embodiment of a data management method, which is implemented using the aforementioned USB device, according to this invention includes the steps shown in FIG. 4.

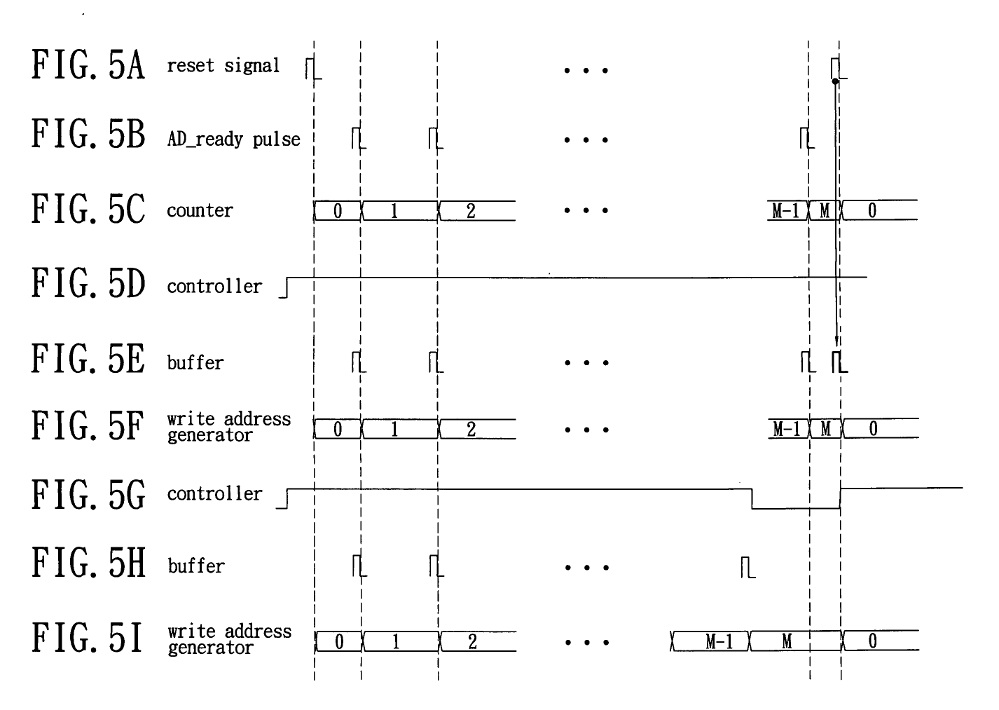

With further reference to FIGS. 5A to 5I, in step 41, if the reset circuit 16 receives the SOF signal from the USB host 300, the flow proceeds to step 42. Otherwise, the flow proceeds to step 45.

In step 42, the controller 12 controls the write enable circuit 13 to enable write operation of the buffer 15.

In step 43, the reset circuit 16 generates a reset signal.

In step 44, the counter 11 receives the reset signal and is reset. The write enable circuit 13 also receives the reset signal. Since, at this time, write operation of the buffer 15 is enabled, the digital sample data latched in the data latch 19 is stored in the buffer 15 at an address location generated by the write address generator 14.

In step 45, the ADC 2 samples the analog input signal at the sampling frequency, and generates digital sample data that corresponds to the samples of the analog input signal.

In step 46, the digital sample data is latched in the data latch 19.

In step 47, if the ADC 2 generates the AD_ready pulse, the flow proceeds to step 48. Otherwise, the flow goes back to step 45.

In step 48, the digital sample data latched in the data latch 19 is stored in the buffer 15.

In step 49, the counter 11 increments the number of the digital sample data monitored thereby.

In step 50, if the controller 12 determines that the number of the digital sample data is less than the predetermined value, the flow goes back to step 41. Otherwise, the flow proceeds to step 51.

In step 51, if the controller 12 determines that the number of the digital sample data is equal to the predetermined value, the flow goes back to step 41. Otherwise, the flow proceeds to step 52.

In step 52, the controller 12 controls the write enable circuit 13 to disable write operation of the buffer 15. Thereafter, the flow goes back to step 41.

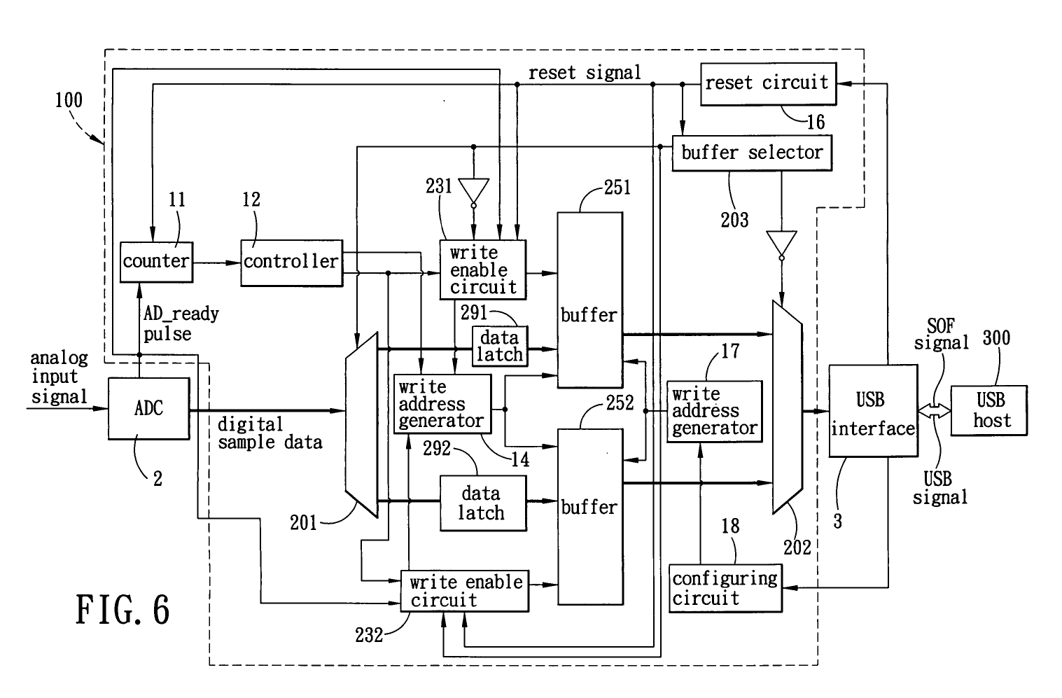

FIG. 6 illustrates the second preferred embodiment of a data management module of a USB device according to this invention. When compared with the previous embodiment, the data processing unit 100 includes a pair of the buffers 251, 252, a pair of the write enable circuits 231, 232, and a pair of the data latches 291. In this embodiment, the data processing unit 100 further includes a buffer selector 203, and first and second data switches 201, 202.

The buffers 251, 252 are selected alternately and respectively during consecutive ones of the predefined time intervals for writing of the digital sample data generated by the ADC 2.

Each of the write enable circuits 231, 232 is connected electrically to the ADC 2 and the reset circuit 16, and is connected electrically between the controller 12 and a respective one of the buffers 251, 252. In this embodiment, the write enable circuits 231, 232 are selected alternately and respectively during the consecutive ones of the predefined time intervals.

The controller 12 controls the selected one of the write enable circuits 231, 232 so as to control in turn write operation of the selected one of the buffers 251, 252.

Each of the data latches 291, 292 is connected to a respective one of the buffers 251, 253.

The first data switch 201 is connected electrically to the ADC 2, and to the buffers 251, 252 through a respective one of the data latches 291, 292, and is operable so as to direct the digital sample data from the ADC 2 to the selected one of the buffers 251, 252. In this embodiment, the first data switch 201 is a demultiplexer.

The second data switch 202 is connected electrically between the buffers 251, 252 and the USB interface 3, and is operable so as to direct the digital sample data from the non-selected one of the buffers 251, 252 to the USB host 300. In this embodiment, the second data switch 202 is a multiplexer.

The buffer selector 203 is coupled to the reset circuit 16, the write enable circuits 231, 232, and the first and second data switches 201, 202. In this embodiment, the buffer selector 203 selects one of the buffers 251, 252 and one of the write enable circuits 231, 232 within the predefined time interval. Furthermore, the buffer selector 203 controls the operation of the first and second data switches 201, 202.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A data management method for a USB device, comprising:
a) sampling an analog input signal at a sampling frequency, and generating digital sample data corresponding to samples of the analog input signal;
b) monitoring the number of the digital sample data generated within a predefined time interval;
c) if the number of the digital sample data generated at the end of the predefined time interval matches a predetermined value, providing the digital sample data to a USB host; and
d) if the number of the digital sample data generated at the end of the predefined time interval does not match the predetermined value, processing the digital sample data such that the number of the processed digital sample data matches the predetermined value, and providing the processed digital sample data to the USB host device.

2. The data management method as claimed in claim 1, wherein, in step d), when the number of the digital sample data generated at the end of the predefined time interval is less than the predetermined value, the number of the digital sample data is processed by adding compensating sample data so as to result in the processed digital sample data, the number of which matches the predetermined value.

3. The data management method as claimed in claim 1, wherein, in step d), when the number of the digital sample data generated by the end of the predefined time interval is greater than the predetermined value, the number of the digital sample data is processed by discarding excess ones of the digital sample data so as to result in the processed digital sample data, the number of which matches the predetermined value.

4. The data management method as claimed in claim 1, wherein, in step b), the number of the digital sample data is monitored using a counter that is reset at the start of the predefined time interval.

5. The data management method as claimed in claim 1, wherein the digital sample data are stored in a buffer before being provided to the USB host, the buffer having a number of addressable storage locations equal to the predetermined value.

6. The data management method as claimed in claim 5, wherein, in step d), when the number of the digital sample data generated at the end of the predefined time interval is less than the predetermined value, the number of the digital sample data is processed by storing compensating sample data in the buffer so as to result in the processed digital sample data, the number of which matches the predetermined value.

7. The data management method as claimed in claim 5, wherein, in step d), when the number of the digital sample data generated by the end of the predefined time interval is greater than the predetermined value, the number of the digital sample data is processed by not storing excess ones of the digital sample data in the buffer so as to result in the processed digital sample data, the number of which matches the predetermined value.

8. A data management module for a USB device, the USB device including an analog-to-digital converter that samples an analog input signal at a sampling frequency and that generates digital sample data corresponding to samples of the analog input signal, said data management module comprising:
a data processing unit adapted to be coupled between the analog-to-digital converter and a USB host, said data processing unit being operable so as to monitor the number of the digital sample data generated within a predefined time interval, so as to provide the digital sample data to the USB host if the number of the digital sample data generated at the end of the predefined time interval matches a predetermined value, and so as to process the digital sample data such that the number of the processed digital sample data matches the predetermined value and so as to provide the processed digital sample data to the USB host if the number of the digital sample data generated at the end of the predefined time interval does not match the predetermined value.

9. The data management module as claimed in claim 8, wherein, when the number of the digital sample data generated at the end of the predefined time interval is less than the predetermined value, said data processing unit processes the number of the digital sample data by adding compensating sample data to result in the processed digital sample data, the number of which matches the predetermined value.

10. The data management module as claimed in claim 8, wherein, when the number of the digital sample data generated by the end of the predefined time interval is greater than the predetermined value, said data processing unit processes the number of the digital sample data by discarding excess ones of the digital sample data to result in the processed digital sample data, the number of which matches the predetermined value.

11. The data management module as claimed in claim 8, wherein said data processing unit includes a counter that monitors the number of the digital sample data, and that is reset at the start of the predefined time interval.

12. The data management module as claimed in claim 8, wherein said data processing unit includes a reset circuit that is operable so as to generate a reset signal for resetting the monitored number of the digital sample data at the start of the predefined time interval.

13. The data management module as claimed in claim 8, wherein said data processing unit includes a buffer for storing the digital sample data that are to be provided to the USB host, said buffer having a number of addressable storage locations equal to the predetermined value.

14. The data management module as claimed in claim 13, wherein said data processing unit further includes a controller for controlling storage of compensating sample data in said buffer to result in the processed digital sample data, the number of which matches the predetermined value, when said controller determines that the number of the digital sample data generated at the end of the predefined time interval is less than the predetermined value.

15. The data management module as claimed in claim 13, wherein said data processing unit further includes a controller for preventing excess ones of the digital sample data from being stored in said buffer to result in the processed digital sample data, the number of which matches the predetermined value, when said controller determines that the number of the digital sample data generated by the end of the predefined time interval is greater than the predetermined value.

16. The data management module as claimed in claim 14, wherein said data processing unit further includes a data latch adapted to be coupled to the analog-to-digital converter, coupled to said buffer, and operable so as to latch a latest one of the digital sample data,
said controller controlling storage of the latest one of the digital sample data latched in said data latch in said buffer so as to result in the processed digital sample data, the number of which matches the predetermined value, when the number of the digital sample data generated at the end of the predefined time interval is less than the predetermined value.

17. The data management module as claimed in claim 16, wherein said data processing unit further includes a write enable circuit coupled between said controller and said buffer, said write enable circuit being controlled by said controller so as to control in turn write operation of said buffer.

18. The data management module as claimed in claim 13, wherein said data processing unit further includes
a write address generator coupled to said buffer, and operable so as generate an address location at which the digital sample data is written to said buffer, and
a read address generator coupled to said buffer, and operable so as to generate an address location at which the digital sample data is read from said buffer.

19. The data management module as claimed in claim 13, wherein said data processing unit further includes a configuring circuit for setting a maximum number of the digital sample data to be read from said buffer within the predefined time interval.

20. The data management module as claimed in claim 13, wherein said buffer is a first-in first-out memory buffer.

21. The data management module as claimed in claim 8, wherein said data processing unit includes a pair of buffers for storing the digital sample data that are to be provided to the USB host, each of said buffers having a number of addressable storage locations equal to the predetermined value, said buffers being selected alternately and respectively during consecutive ones of the predefined time intervals.

22. The data management module as claimed in claim 21, wherein said data processing unit further includes a controller for controlling storage of compensating sample data in the selected one of said buffers so as to result in the processed digital sample data, the number of which matches the predetermined value, when said controller determines that the number of the digital sample data generated at the end of the predefined time interval is less than the predetermined value.

23. The data management module as claimed in claim 21, wherein said data processing unit further includes a controller for preventing excess ones of the digital sample data from being stored in the selected one of said buffers so as to result in the processed digital sample data, the number of which matches the predetermined value, when said controller determines that the number of the digital sample data generated by the end of the predefined time interval is greater than the predetermined value.

24. The data management module as claimed in claim 22, wherein said data processing unit further includes a pair of data latches, each of which is adapted to be coupled to the analog-to-digital converter, is coupled to a respective one of said buffers, and is operable so as to latch a latest one of the digital sample data,
said controller controlling storage of the latest one of the digital sample data latched in the respective one of said data latches in the selected one of said buffers so as to result in the processed digital sample data, the number of which matches the predetermined value, when the number of the digital sample data generated at the end of the predefined time interval is less than the predetermined value.

25. The data management module as claimed in claim 24, wherein said data processing unit further includes a pair of write enable circuits, each of which is coupled between said controller and a respective one of said buffers, said write enable circuits being controlled by said controller so as to control in turn write operation of the selected one of said buffers.

26. The data management module as claimed in claim 21, wherein said data processing unit further includes
a write address generator coupled to said buffers, and operable so as generate an address location at which the digital sample data is written to the selected one of said buffers, and
a read address generator coupled to said buffers, and operable so as to generate an address location at which the digital sample data is read from the non-selected one of said buffers.

27. The data management module as claimed in claim 21, wherein said data processing unit further includes a configuring circuit for setting a maximum number of the digital sample data to be read from the non-selected one of said buffers within the predefined time interval.

28. The data management module as claimed in claim 21, wherein said data processing unit further includes:
a first data switch adapted to receive the digital sample data generated by the analog-to-digital converter, and operable so as to direct the digital sample data from the analog-to-digital converter to the selected one of said buffers, and
a second data switch coupled to said buffers, adapted to be coupled to the USB host, and operable so as to direct the digital sample data from the non-selected one of said buffers to the USB host.

29. The data management module as claimed in claim 21, wherein said data processing unit further includes a buffer selector for selecting one of said buffers within the predefined time interval.

30. The data management module as claimed in claim 8, wherein said data processing unit includes:
a buffer for storing the digital sample data that are to be provided to the USB host, said buffer having a number of addressable storage locations equal to the predetermined value;
a counter for monitoring the number of the digital sample data, said counter being reset at the start of the predefined time interval;
a controller for controlling storage of compensating sample data in said buffer to result in the processed digital sample data, the number of which matches the predetermined value, when said controller determines that the number of the digital sample data generated at the end of the predefined time interval is less than the predetermined value; and
a write enable circuit coupled between said controller and said buffer, said write enable circuit being controlled by said controller so as to control in turn write operation of said buffer.

31. The data management module as claimed in claim 8, wherein said data processing unit includes:
a pair of buffers for storing the digital sample data that are to be provided to the USB host, each of said buffers having a number of addressable storage locations equal to the predetermined value, said buffers being selected alternately and respectively during consecutive ones of the predefined time intervals;
a write address generator coupled to said buffers, and operable so as generate an address location at which the digital sample data is written to the selected one of said buffers;
a read address generator coupled to said buffers, and operable so as to generate an address location at which the digital sample data is read from the non-selected one of said buffers;
a buffer selector for selecting one of said buffers within the predefined time interval;
a first data switch adapted to receive the digital sample data generated by the analog-to-digital converter, and operable so as to direct the digital sample data from the analog-to-digital converter to the selected one of said buffers; and
a second data switch coupled to said buffers, adapted to be coupled to the USB host, and operable so as to direct the digital sample data from the non-selected one of said buffers to the USB host.
